(19) United States
(12) Patent Application Publication
(10) Pub. No.: US 2005/0108058 A1
(43) Pub. Date: May 19, 2005

(54) Management of dental records and digital images

(75) Inventors: Susan M. Weidner, Ontario, NY (US); Joseph M. St. Germaine, Fairport, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/961,275

(22) Filed: Oct. 8, 2004

Related U.S. Application Data
(60) Provisional application No. 60/510,409, filed on Oct. 10, 2003.

(51) Int. Cl. G06F 17/60

(52) U.S. Cl. 705/3

(57) ABSTRACT

A system and method for managing dental digital images and records. The method comprises the steps of providing a system having a central server in network communication with a plurality of dental locations, a plurality of service providers remote from the plurality of dental locations, and at least one storage device; acquiring, at one of the plurality of dental locations, a plurality of digital images of a patient's teeth to generate a set of dental records; transmitting a requesting message from the one dental location to at least one of the plurality of service providers over the communication network through the central server, the requesting message including a request for service and the dental records; providing a confirmation of the transmittal of the requesting message to the one dental location; permitting the one dental location to review a status of the requesting message; transmitting a responding message from the at least one service provider to the one dental location over the communication network through the central server, the responding message indicating an acceptance or rejection of the requesting message; and providing a confirmation of the transmittal of the responding message to the at least one service provider.

### CROSS REFERENCE TO RELATED APPLICATIONS

This is a 111 (a) application of U.S. Ser. No. 60/510,409, entitled “METHOD AND SYSTEM FOR MANAGING DIGITAL IMAGES AND DENTAL RECORDS OVER A COMMUNICATION NETWORK”, filed on Oct. 10, 2003 in the names of Susan M. Weidner and Joseph M. St. Germaine, incorporated herein by reference.

### FIELD OF THE INVENTION

The invention relates generally to the field of dental information systems, and in particular to methods and systems for managing digital dental images and dental records over a communication network.

### BACKGROUND OF THE INVENTION

Methods are known for managing and printing digital images. For example, U.S. Pat. No. 6,332,146 (Jebens) is directed to a method and apparatus for storing and printing digital images and U.S. Pat. No. 6,321,231 (Jebens) is directed to a data management and order delivery system.

Digital imaging has been employed in dental applications. For example, U.S. Patent Application No. 2002/0064750 (Morris) is directed to an automated tooth shade analysis and matching system.

While such systems may have achieved certain degrees of success in their particular applications, there is a need for a method for managing digital dental images and dental records over a communication network.

### SUMMARY OF THE INVENTION

An object of the present invention is to provide a method for managing digital dental images and dental records over a communication network.

Another object of the present invention is to provide such a method which is secure.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a method for managing dental digital images and records on a system having a central server in network communication with a plurality of dental locations, a plurality of service providers remote from the plurality of dental locations, and at least one storage device. At one of the plurality of dental locations, a plurality of digital images of a patient's teeth is acquired to generate a set of dental records. A requesting message is transmitted from the one dental location to at least one of the plurality of service providers over the communication network through the central server, the requesting message includes a request for service and the dental records. A confirmation of the transmittal of the requesting message is provided to the one dental location. The one dental location is permitted to review a status of the requesting message. A responding message is transmitted from the at least one service provider to the one dental location over the communication network through the central server, the responding message indicates an acceptance or rejection of the requesting message. A confirmation of the transmittal of the responding message is provided to the at least one service provider.

In one embodiment, the requesting message is a single message and is transmitted from the one dental location to a plurality of service providers over the communication network through the central server, and the requesting message does not indicate that the requesting message was sent to a plurality of service providers.

In a further embodiment, the dental records are stored on the at least one storage device, and the requesting message provides the at least one service provider with authorization to access to the dental records stored on the at least one storage device.

According to another aspect of the invention, there is provided a system for managing dental digital images and record. The system includes a central server and a software application. The central server is in network communication with a plurality of dental locations, a plurality of service providers remote from the plurality of dental locations, and at least one storage device. The plurality of dental locations each includes a digital capture device adapted to capture a plurality of digital images of a patient's teeth. The software application operates over the communication network and is adapted to (1) transmit a requesting message from one of the plurality of dental locations to at least one of the plurality of service providers through the central server, wherein the requesting message includes the plurality of captured digital dental images, (2) transmit a responding message from the at least one service provider to the one of the plurality of dental locations through the central server, wherein the responding message includes an acceptance or rejection of the requesting message, (3) provide a confirmation of the transmittal of the requesting message to the one of the plurality of dental locations, (4) provide a confirmation of the transmittal of the responding message to the at least one service provider, and (5) permit the one of the plurality of dental locations to review a status of the requesting message.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 shows a system in accordance with the present invention.

FIG. 2 shows a screen capture illustrating a patient record and the input, manipulation, and storage of digital records and digital images FIG. 3 shows a screen capture illustrating pull-down menus to manage and access patent information.

FIG. 4 shows a screen capture illustrating the granting and/or revoking access of patient information.

FIG. 5 shows a screen capture illustrating the manipulation of digital images and records.

FIG. 6 shows a screen capture illustrating a template arrangement for digital images.

FIGS. 7, 8, and 9 shows screen captures illustrating editing and/or printing of the dental digital images.

FIG. 10 shows a screen capture illustrating an email facility in accordance with the present invention.

FIG. 11 shows a screen capture illustrating selecting an email recipient from a listing.

FIG. 12 shows a screen capture illustrating the composition and inclusion of an attachment in an email.

FIG. 13 shows a screen capture illustrating an authorization for a patient record.

FIG. 14 shows a screen capture illustrating confirmation of the transmittal of a third-party request.

FIG. 15 shows a screen capture illustrating the tracking of a third-party request.

FIG. 16 shows a screen capture illustrating the receipt of the request by the third party.

FIGS. 17-19 show screen captures illustrating a response from the third party regarding the request, the response including text, annotation, and/or acceptance/rejection.

FIG. 20 shows a screen capture illustrating a confirmation number/message for the third party's response to the originator/sender.

FIG. 21 shows a screen capture illustrating the ability to list patients that the third party has been asked to review.

FIG. 22 shows a flow chart illustrating a method in accordance with the present invention.

### DETAILED DESCRIPTION OF THE INVENTION

The following is a detailed description of the preferred embodiments of the invention, reference being made to the drawings in which the same reference numerals identify the same elements of structure in each of the several figures.

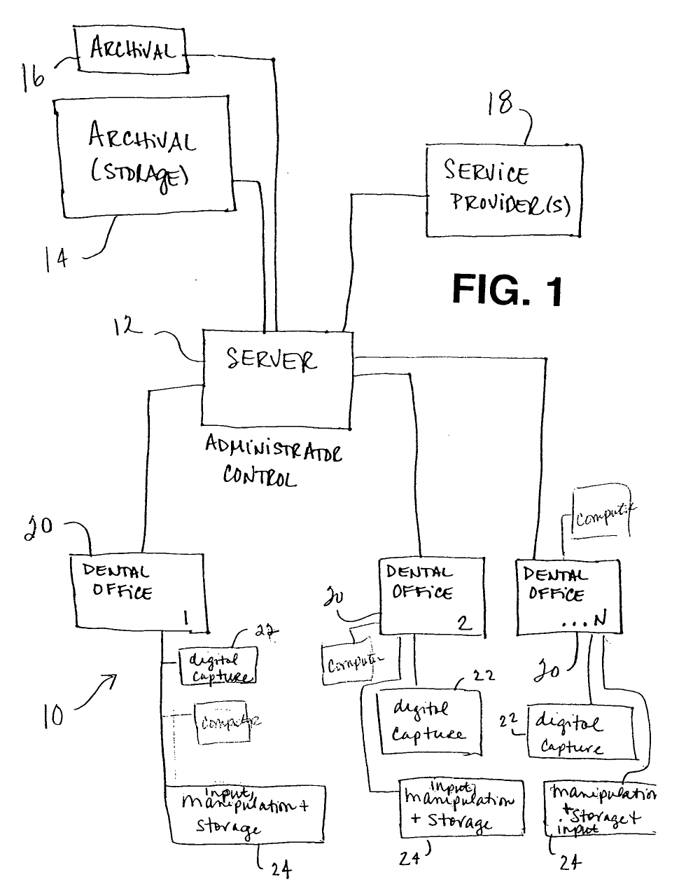

FIG. 1 generally illustrates a system 10 in accordance with the present invention. System 10 supports a software application executing in an electronic system configured to practice the method in accordance with the present invention. The software application can operate on any operating system or environment, as would be known to those skilled in the art.

System 10 includes a central computer or server 12 in network communication with one or more storage/archival devices 14,16, one or more service providers 18, and one or more dental offices/locations 20. The software application of the present invention is configured to operate on system 10. Portions of the software application may reside on server 12 or at dental offices 20.

At each dental location 20 is a digital capture device 22, such as a digital camera. Each dental location 20 further includes means 24 for inputting, manipulating, storing digital dental records and digital dental images captured using digital capture device 22.

Server 12 acts as an administrator or controller of system 10, and operates to transmit digital information between storage devices 14,16, service providers 18, and dental offices 20.

Archival devices 14,16 are well known.

Service provider 18 can be a provider of service to dental professionals. One example of a service provider is a laboratory that provides dental prosthetics and/or shade matching and/or braces. Another example of a service provider is an insurance company or health care provider that reviews and/or pays for dental services. Yet a further example of a service provider is a dental specialist, such as an orthodontist, or another dental office. Still another example of a service provider is an online photofinisher. Other examples of service providers will be known to those skilled in the art.

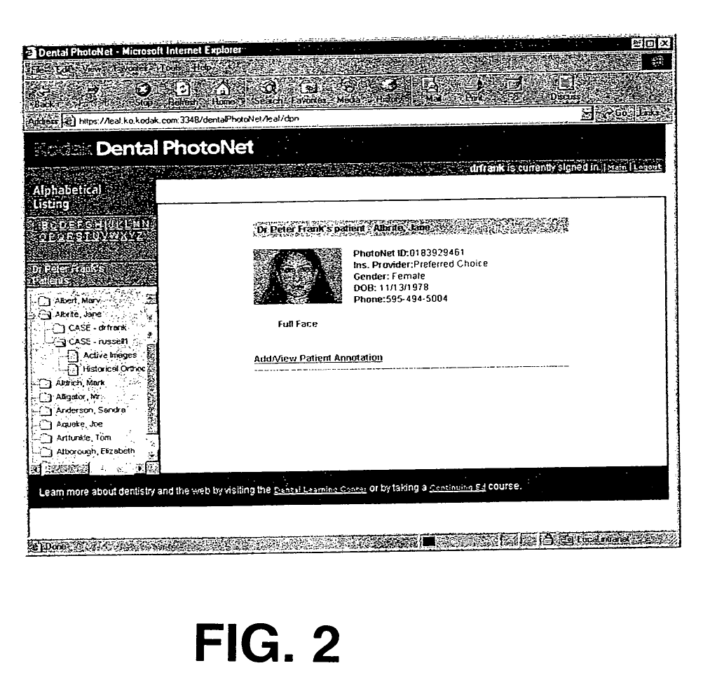

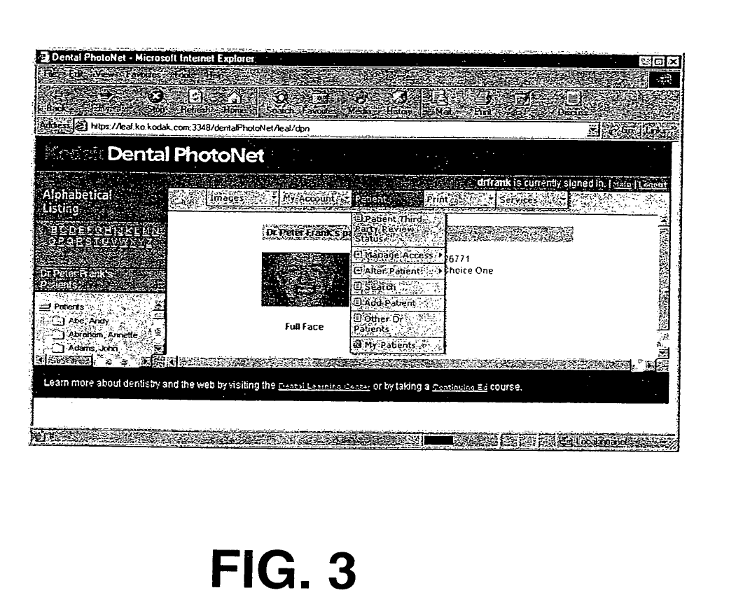

Means 24, located at each dental office 20, for inputting, manipulating, storing digital dental records and digital dental images includes means for inputting, editing, and storing patient information (e.g., name, address, insurance information, type of dental work done, date of next appointment) in a patient record. Such means can include a user interface such as that shown in FIG. 2.

Also associated with each patient record is the name of the dentist authorized to access the patient's records. One dentist is the owner of the record, and the owning dentist can authorize others (i.e., those accessible over the network, for example, service providers 18 and dental offices 20) to access to the patient record. Access to the patient record can be full access or limited in some manner, for example, access only to dental images (for a lab to make a prosthetic), access only to billing information, access only to upload/download an image, authorization to annotate the patient's record.

The patient record can also include images, such as shown in FIG. 2.

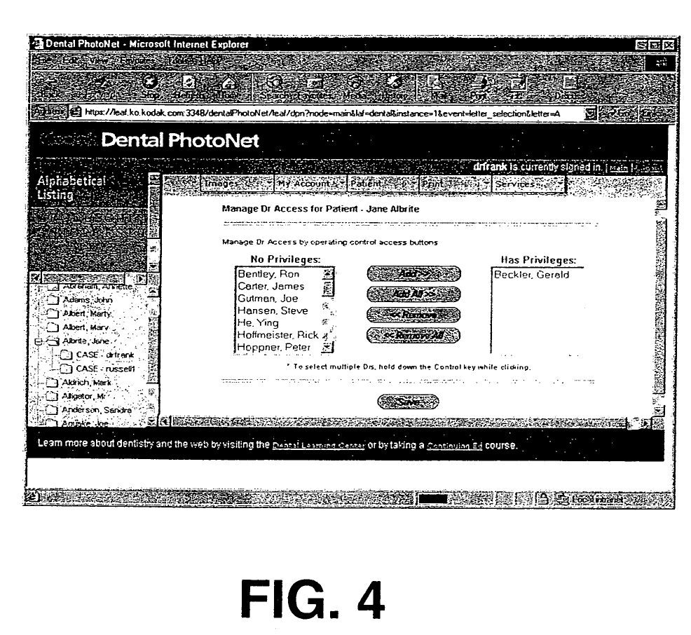

Access and management of the patient record can be accomplished by the owner dentist using pull-down menus such as shown in FIG. 3. FIG. 4 shows one method by which an owner dentist can grant/revoke access of a patient record to another dentist or entity (i.e., service provider or archive storage).

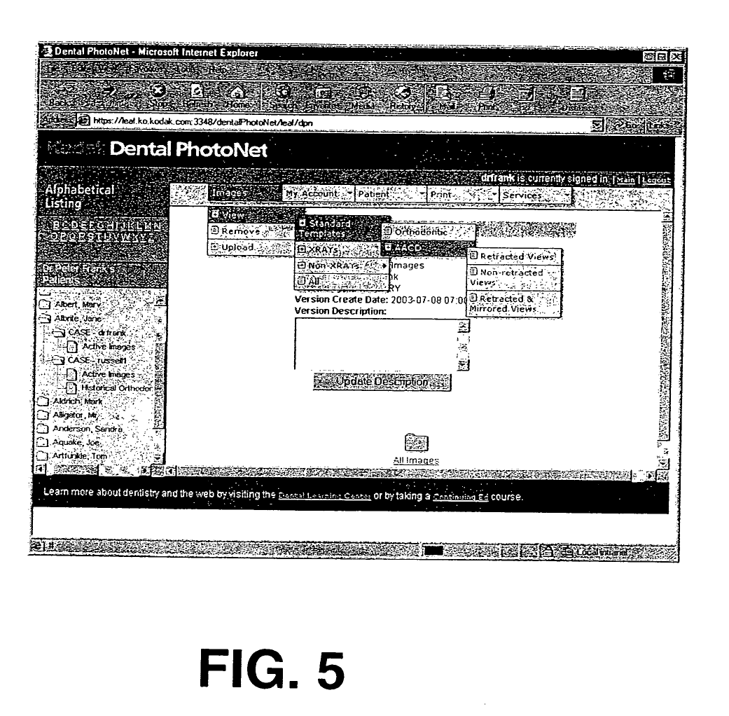

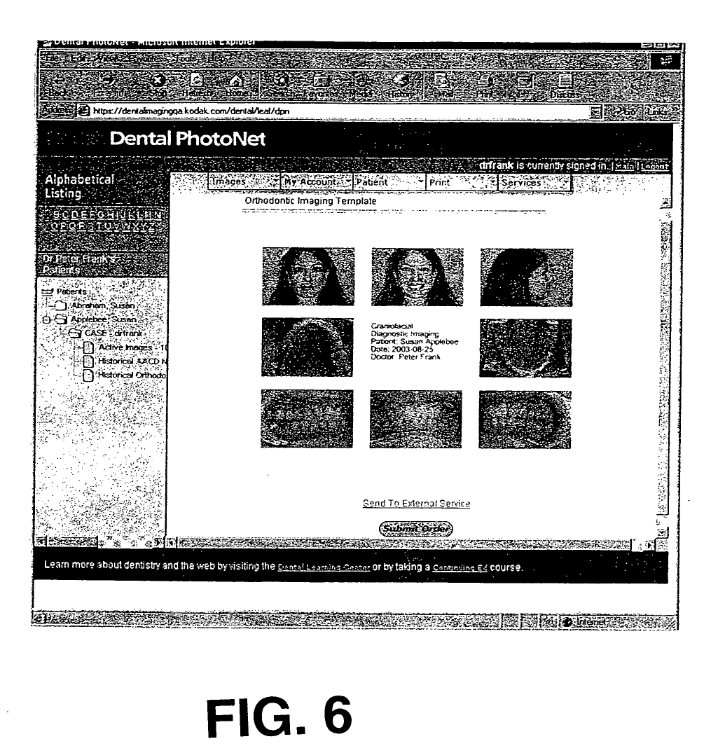

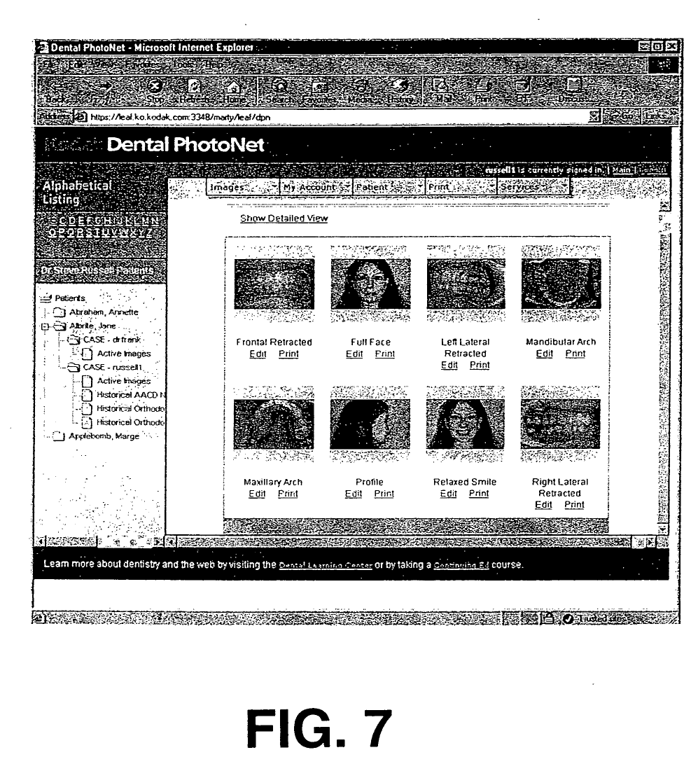

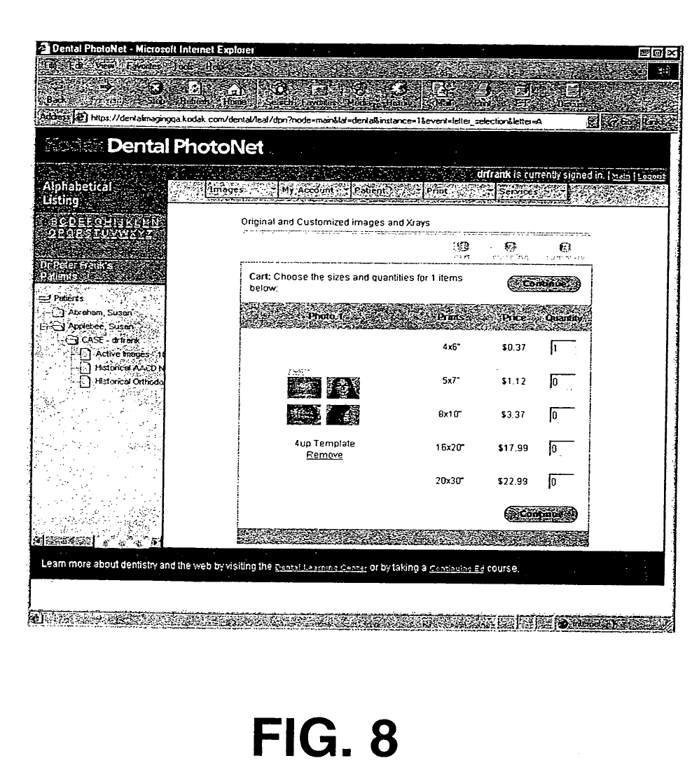

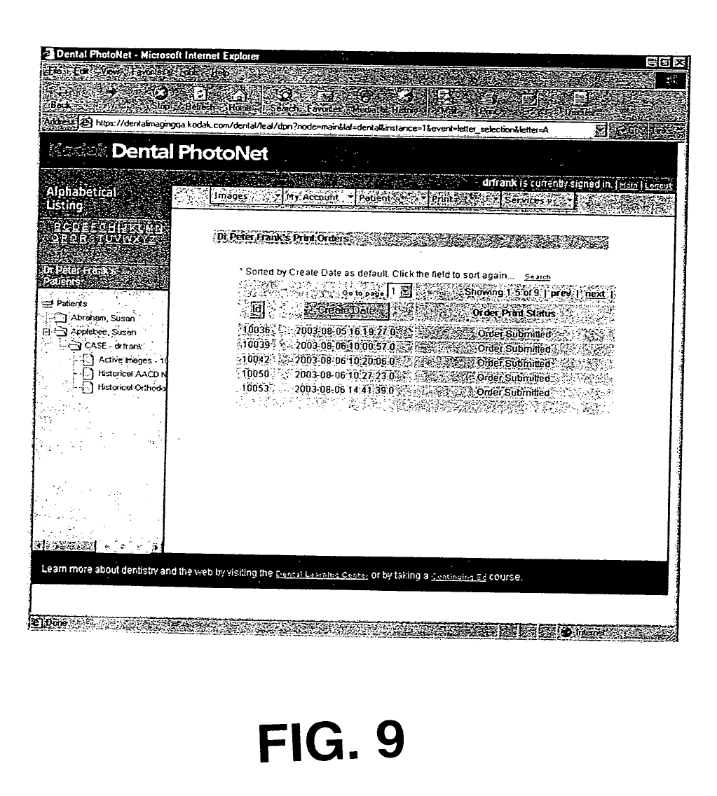

Pull-down menus can be used to manipulate the images, such as shown in FIG. 5. Templates can be provided to store/display images in a desired format, such as shown in FIG. 6. The images can be edited and printed, such as shown in FIG. 7. The images can be printed locally at the dentist office, or transmitted over the communication network to a service provider for printing, such as shown in FIGS. 8 and 9.

Low resolution images of the dental records might be provided for local viewing on a display, such as shown in the screen capture images of FIGS. 6-8. However, high resolution images would be transmitted for printing.

System 10 further includes an internal email facility which provides for the transmission of emails over the communication network allows those connected to the network to share emails in a secure method. The email facility also allows the sharing of patient information (all or portions of a patient's record) through attachments. That is, a sender can attach an attachment to include in an email to a recipient such that the recipient can view a patient record. The email facility is preferably controlled by server 12.

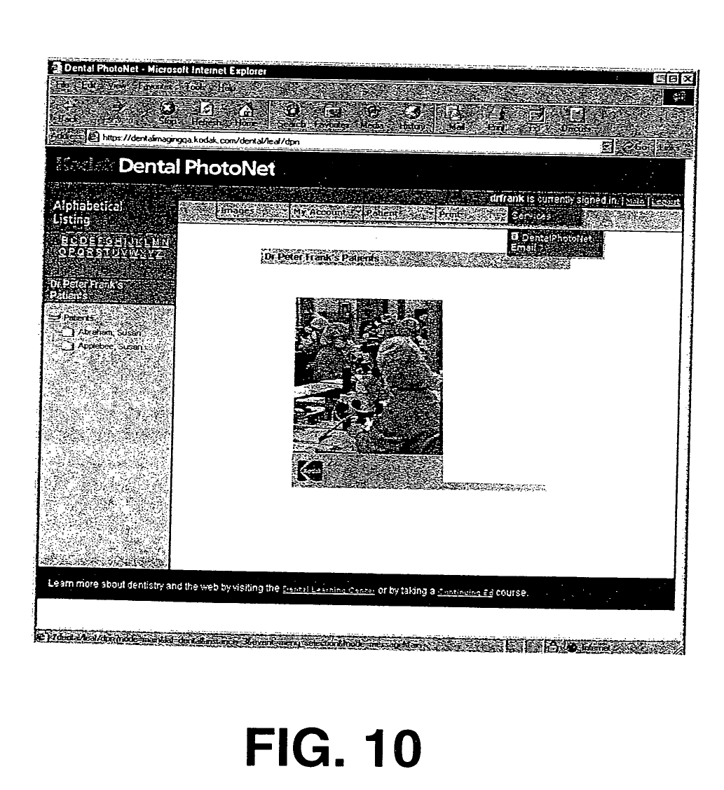

The email can be activated/initiated through a pull-down menu, as shown in FIG. 10.

The email facility includes features common to standard, well-known email packages. For example, a user can organize emails into categories (inbox, draft, sent), organized received emails, review received emails, and the like.

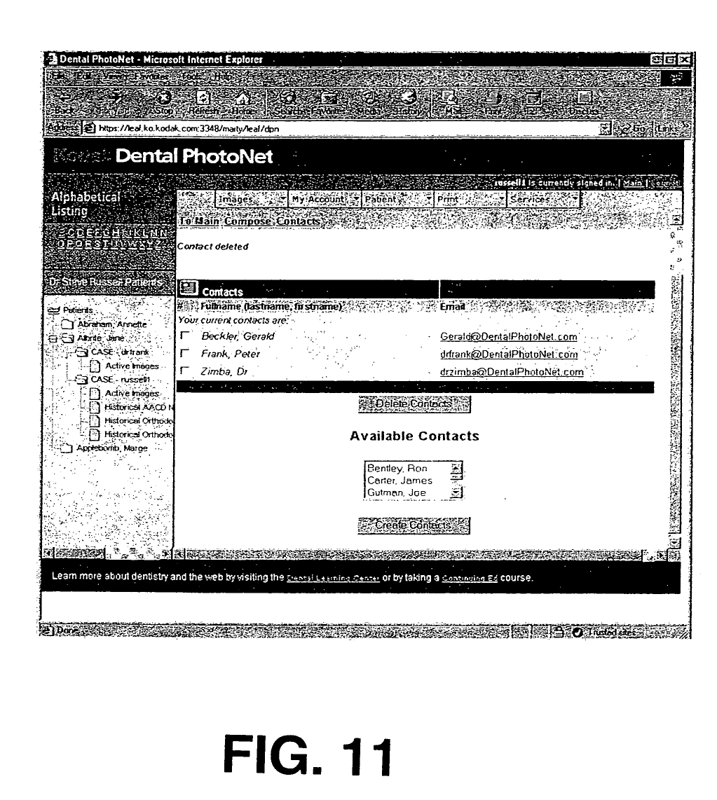

The email facility can include features not common to standard email packages. For example, the email facility of the present invention allows a user to create and manage email contacts. This can be accomplished, for example, using a “contacts” link. FIG. 11 shows a list of contacts from a community listing from which the user can select, the community listing being a list of the possible recipients on the communication network. The community listing can be customized to a particular user by adding/deleting contacts.

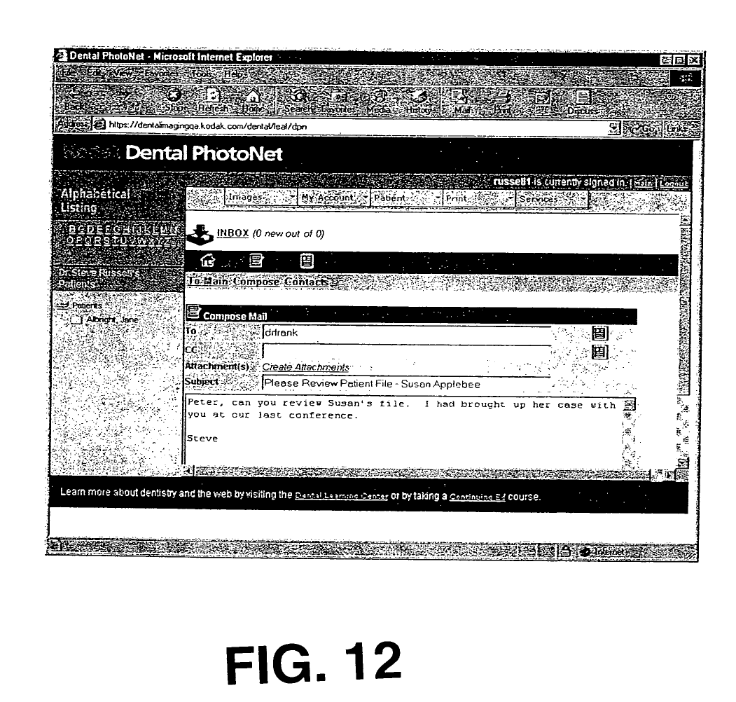

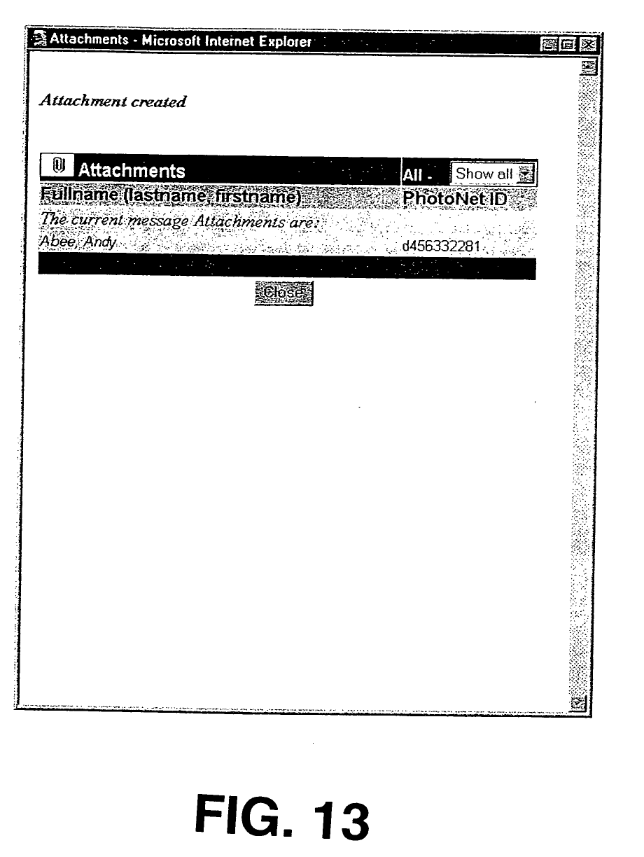

With a contact selected, a user can compose an email and include an attachment, as shown in FIG. 12. By including an attachment, the recipient will be allowed to review the patient record which is attached. The actual patient record need not be physically attached to the email. Rather, the attachment of the email provides access/authorization to the particular patient record. That is, the attachment can be an authorization code/password/ID to access other dentist's records. The authorization can be a code/password/ID or metadata attached to the particular patient record that recognizes that the recipient can access that particular patient record. An example is shown in FIG. 13. Referring back to FIG. 3, the recipient can access other dentist's records using the “other Dr patients” menu bar and the attachment authorization received through the email.

Multiple recipients can receive the same email and attachment, thus multiple authorizations can be accomplished using a single email.

System 10 of the present invention can provide for a third-party review process. That is, at the request of an owner, a third-party can obtain access to particular information in order to make a assessment of some type. The third-party (individual or organization) would need to be in communication with the server in order to receive the third-party request.

An example of a third-party request is a first dentist (owner of the patent information) requesting that a specialist, such as an orthodontist, provide an assessment of a particular patient's need for braces. The owner dentist can send a third party review request to one or more specific orthodontist or there can be orthodontists on the network who have indicated that they are available/willing to conduct reviews and/or accept new patients. While the owner dentist may identify him/herself, the owner dentist need not identify the patient—only the dental images need to be shared.

Referring back to FIG. 6, an available menu option can be a “Send to External Service” link.

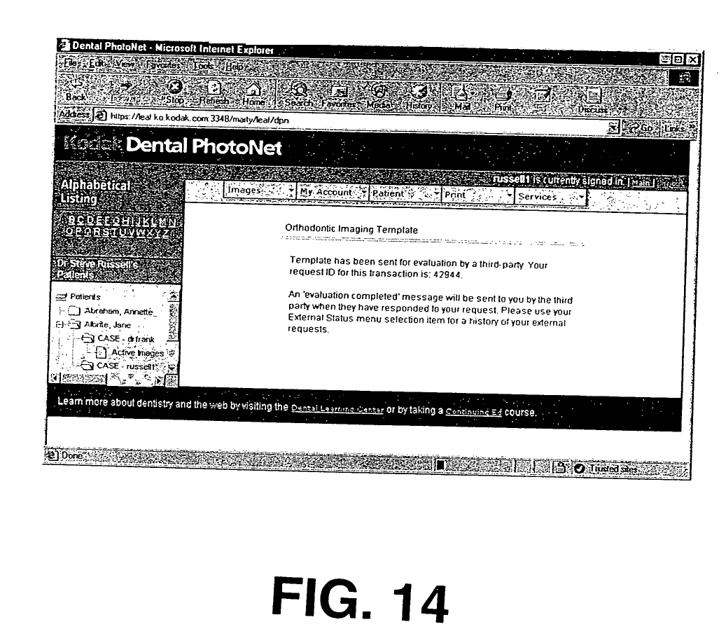

After submitting the request, a confirmation can be shown with confirmation information, such as a number. This is shown in FIG. 14.

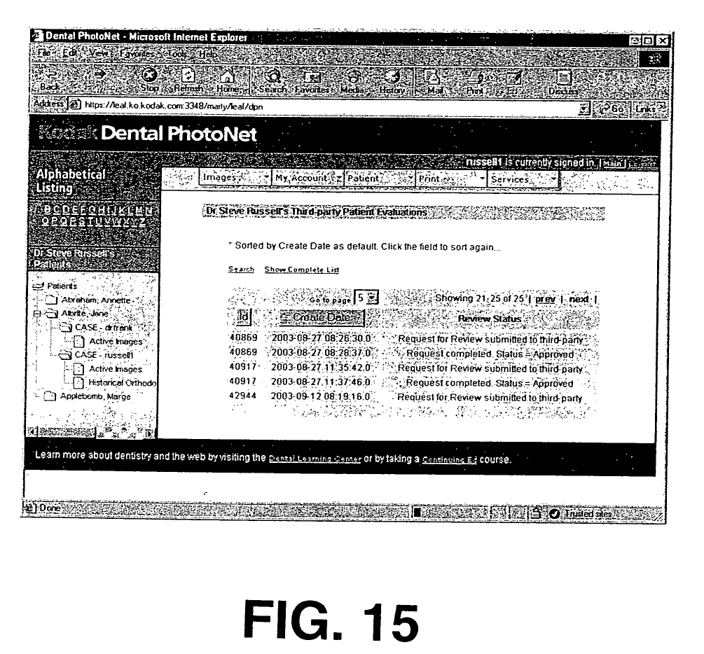

The status of the request can be tracked, as shown in FIG. 15. The confirmation number can be used to track the request. A status can be provided, for example, if the request is for confirmation of payment for the procedure, the status options might be: reviewing, pending, approved, and denied.

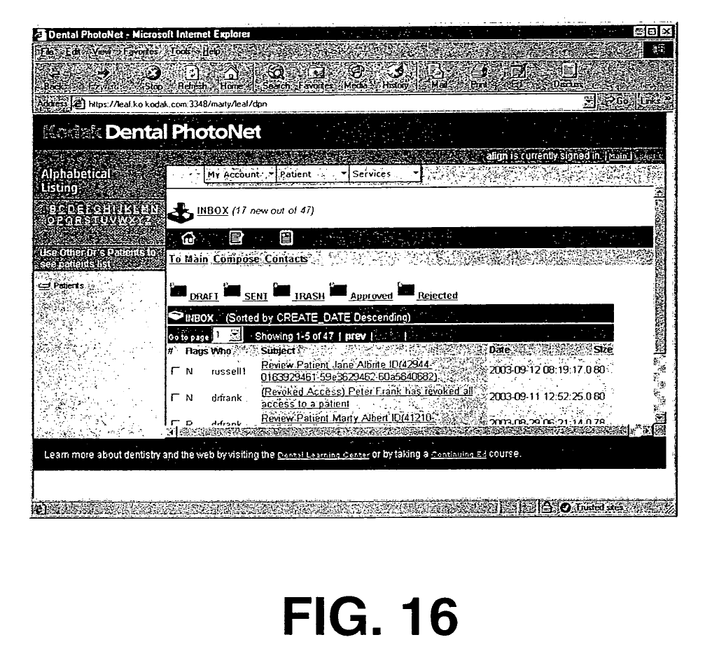

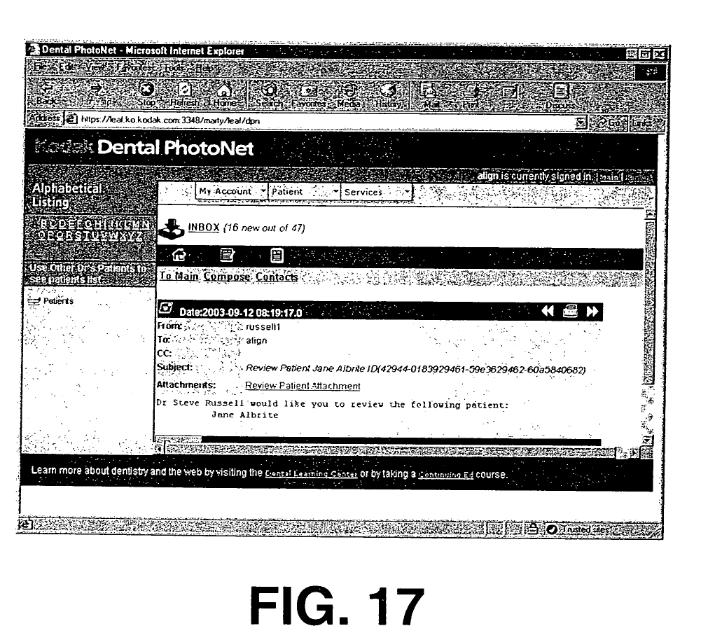

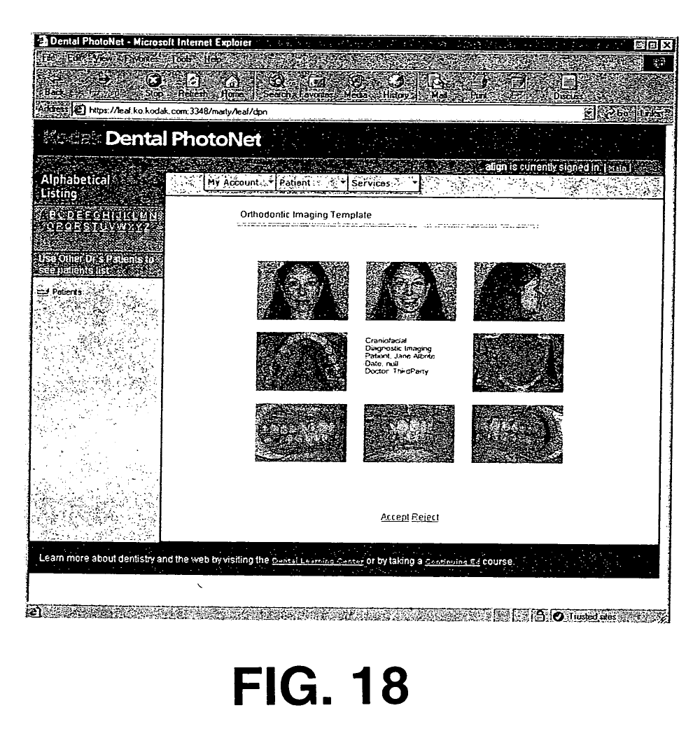

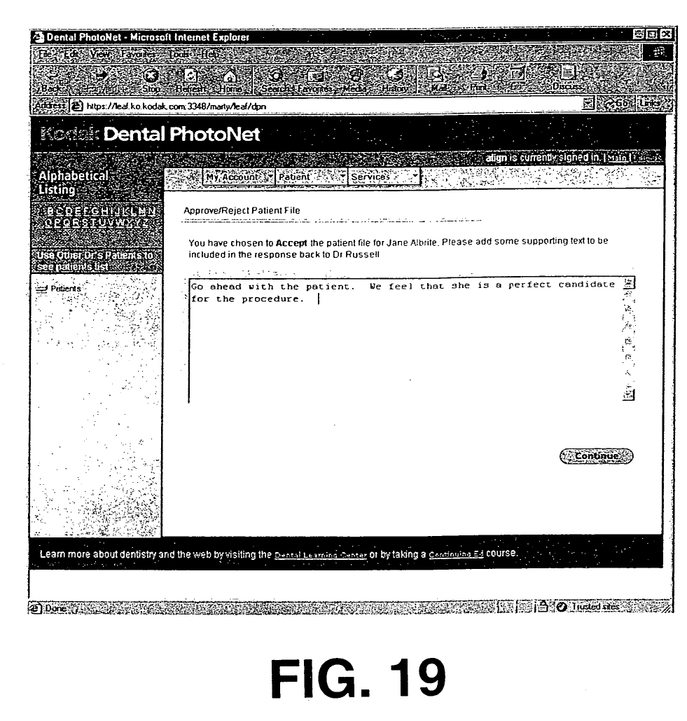

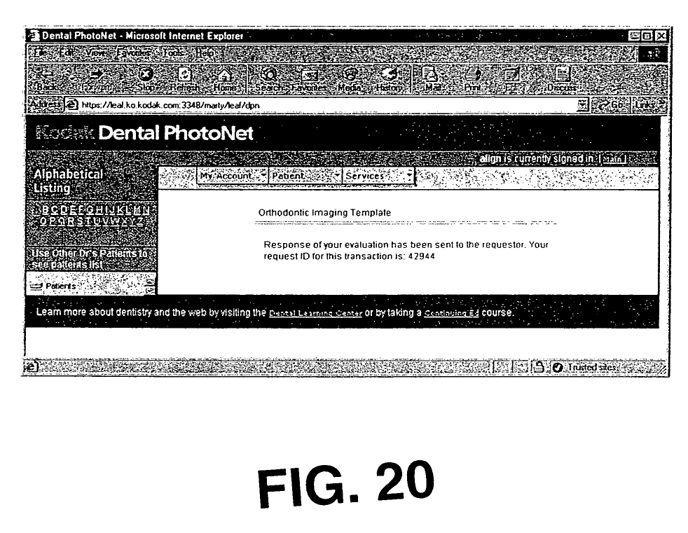

The third-party reviewer (which could be an organization, service provider and the like) can review the community member's request for evaluation by accessing system 10 and receiving email with the request, such as shown in FIG. 16. Once accessed, the third-party reviewer can select the attachment to open and review the attachment. If appropriate, the third-party reviewer can add supporting text/annotation and accept or reject the owner dentist's request. Refer to FIGS. 17-19. A confirmation number/message can be sent to the third-party reviewer upon sending of a response to the originator of the request (i.e., the owner dentist), as shown in FIG. 20.

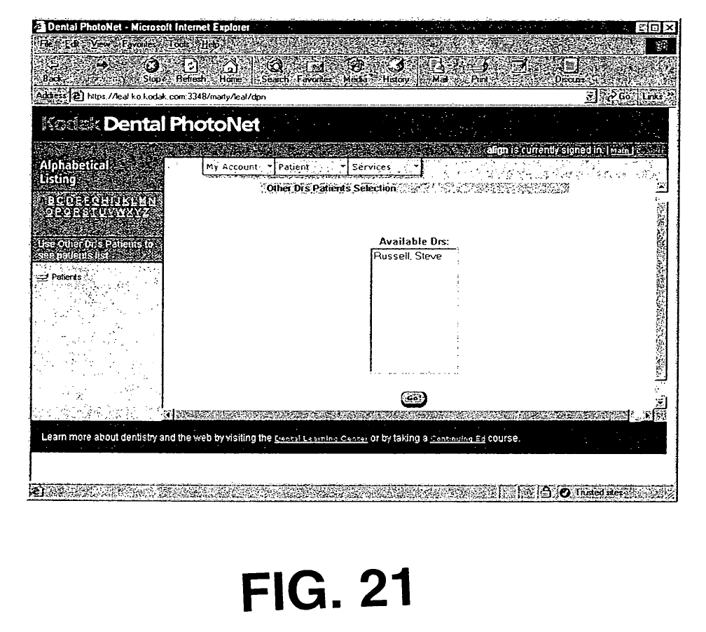

It may be desirable to allow the third-party reviewer to have a listing of the patients that the third-party reviewer has been asked to review. This listing can be organized by owner dentist, such as shown in FIG. 21. By this organization method, once an owner dentist is selected, all patients under the selected dentist will be listed. If there is no pending response due to the owner dentist (i.e., a response was already sent), the owner dentist might provide the reviewer with “view only” access to the patient information.

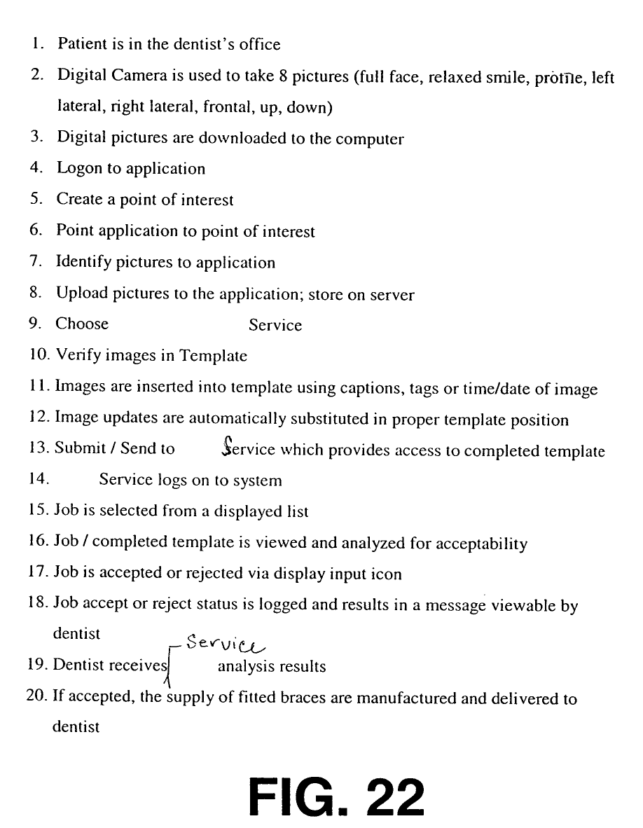

Referring to FIG. 22, it is envisioned that system 10 of the present invention can be employed to assist a dentist in ordering braces for a patient. As dentist office 20, the dentist captures images of the patient using digital capture device 22. Once captured, the digital images can be inputted, manipulated, and stored in device 24. Preferably, eight images are captured to generate a full template, such as shown in FIG. 6. At dental office 20, a dentist logs onto the application of the present invention and uploads the captured images into the application. The uploaded images can be stored on archive device 14. A service provider 18 is chosen. An email is sent to the selected service provider, including the digital images (in the template) along with some text/annotations indicating the dentist's request to the service provider. Service provider 18 logs onto the application and detects the presence of a request from the dentist. The request is opened and reviewed for acceptability. An acceptance or rejection can be indicated. If accepted, the request is logged and transmitted to the requesting dentist. If an analysis is requested, the analysis can be sent to the dentist. After which, the request is processed accordingly, and the result (i.e., braces for this example) are sent to the dentist.

The dentist may desire to obtain quotes/reviews from more than one service provider. Accordingly, the dentist may choose more than one service provider 18, and send the email to a plurality of service providers, the email including the digital images (in the template) along with some text/annotations indicating the dentist's request to the service providers and indicating a request for proposal from the service provider. If more than one service provider was selected, the email message would preferably not list/indicate the other service providers being asked for proposals so as to maintain confidentiality/privacy. Each of the service providers 18 would log onto the application and detect the presence of a request from the dentist. Each request is opened and reviewed and a response is sent back to the dentist, for example, including a quote. The dentist can review the responses from the service providers and make a determination how to proceed. If one service provider is selected, the dentist can send an email to the selected service provider indicating acceptance. After which, the request is processed accordingly, and the result (i.e., braces for this example) are sent to the dentist.

Accordingly, the application of the present invention provides a method for enabling access/transmission of dental images as well as promoting an interaction capability between dentists and related dental service providers.

Digital images captured using capture device 22 can include tags/metadata or object recognition such that the captured images can be automatically placed in standard dental templates. Thus, rather than manipulating images by “dragging and dropping”, the tag/metadata can match the tag of the template area.

A computer program product may include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A method for managing dental digital images and records, comprising the steps of:
providing a system having a central server in network communication with a plurality of dental locations, a plurality of service providers remote from the plurality of dental locations, and at least one storage device;
acquiring, at one of the plurality of dental locations, a plurality of digital images of a patient's teeth to generate a set of dental records;
transmitting a requesting message from the one dental location to at least one of the plurality of service providers over the communication network through the central server, the requesting message including a request for service and the dental records;
providing a confirmation of the transmittal of the requesting message to the one dental location;
permitting the one dental location to review a status of the requesting message;
transmitting a responding message from the at least one service provider to the one dental location over the communication network through the central server, the responding message indicating an acceptance or rejection of the requesting message; and
providing a confirmation of the transmittal of the responding message to the at least one service provider.

2. The method of claim 1, wherein the requesting message is a single message and is transmitted from the one dental location to a plurality of service providers over the communication network through the central server, the requesting message not indicating that the requesting message was sent to a plurality of service providers.

3. The method of claim 1, wherein the dental records are stored on the at least one storage device, and the requesting message provides the at least one service provider with authorization to access to the dental records stored on the at least one storage device.

4. A system for managing dental digital images and records, comprising:
a central server in network communication with a plurality of dental locations, a plurality of service providers remote from the plurality of dental locations, and at least one storage device;
the plurality of dental locations each including a digital capture device adapted to capture a plurality of digital images of a patient's teeth; and
a software application operating over the communication network and adapted to (1) transmit a requesting message from one of the plurality of dental locations to at least one of the plurality of service providers through the central server, wherein the requesting message includes the plurality of captured digital dental images, (2) transmit a responding message from the at least one service provider to the one of the plurality of dental locations through the central server, wherein the responding message includes an acceptance or rejection of the requesting message, (3) provide a confirmation of the transmittal of the requesting message to the one of the plurality of dental locations, (4) provide a confirmation of the transmittal of the responding message to the at least one service provider, and (5) permit the one of the plurality of dental locations to review a status of the requesting message.

5. A computer storage product having at least one computer storage medium having instructions stored therein causing one or more computers to perform the method of claim 1.
